(19) United States
(12) Patent Application Publication
(10) Pub. No.: US 2011/0103486 A1
(43) Pub. Date: May 5, 2011

(54) IMAGE PROCESSING APPARATUS AND IMAGE PROCESSING METHOD

(76) Inventors: Kazushi Sato, Kanagawa (JP); Yoichi Yagasaki, Tokyo (JP)

(21) Appl. No.: 13/001,373

(22) PCT Filed: Jul. 1, 2009
(86) PCT No.: PCT/JP2009/062026

§ 371 Date: Dec. 23, 2010

(30) Foreign Application Priority Data
Jul. 1, 2008 (JP) 2008-172269

(51) Int. Cl. H04N 7/32

(52) U.S. Cl. 375/240.16; 375/E07.123

(57) ABSTRACT

The present invention relates to an image processing apparatus and an image processing method capable of preventing a decrease in compression efficiency. A template motion prediction/compensation unit 76 performs an integer-pixel based motion prediction and compensation process in an inter template prediction mode on the basis of an image read from a re-ordering screen buffer 62 and to be subjected to an inter encoding process and a reference image supplied from a frame memory 72 via a switch 73. A sub-pixel accuracy motion prediction/compensation unit 77 performs a sub-pixel based motion prediction and compensation process in an inter template prediction mode on the basis of the image read from the re-ordering screen buffer 62 and to be subjected to an inter encoding process and the reference image supplied from the frame memory 72 via the switch 73. The present invention is applicable to, for example, an image encoding apparatus that performs encoding using the H.264/AVC standard.

### TECHNICAL FIELD

The present invention relates to an image processing apparatus and an image processing method and, in particular, to an image processing apparatus and an image processing method capable of preventing a decrease in compression efficiency.

### BACKGROUND ART

In recent years, a technology for compression-encoding an image using a compression-encoding method, such as MPEG (Moving Picture Experts Group) 2 or H.264 and MPEG-4 Part 10 (Advanced Video Coding) (hereinafter referred to as “H.264/AVC”), packetizing the image, and decoding the image at the receiving end has been widely used. Thus, users can view a high-quality moving image.

In addition, in the MPEG2 standard, a motion prediction/compensation process with ½-pixel accuracy using a linear interpolation process is performed. In contrast, in the H.264/AVC standard, a motion prediction/compensation process with ¼-pixel accuracy using a 6-tap FIR (Finite Impulse Response Filter) is performed.

Furthermore, in the MPEG2 standard, in the case of a frame motion compensation mode, a motion prediction/compensation process is performed on per 16×16 pixel basis. However, in the case of a field motion compensation mode, a motion prediction/motion compensation process is performed for each of first and second fields on per 16×8 pixel basis.

In contrast, in the H.264/AVC standard, a motion prediction/compensation process can be performed on the basis of a variable block size. That is, in the H.264/AVC standard, a macroblock including 16×16 pixels is separated into one of 16×16 partitions, 16×8 partitions, 8×16 partitions, and 8×8 partitions. Each of the partitions can have independent motion vector information. In addition, an 8×8 partition can be separated into one of 8×8 sub-partitions, 8×4 sub-partitions, 4×8 sub-partitions, and 4×4 sub-partitions. Each of the sub-partitions can have independent motion vector information.

However, in the H.264/AVC standard, when the above-described motion prediction/compensation process with ¼-pixel accuracy is performed on the basis of a variable block size, an enormous number of motion vector information items are disadvantageously generated. If these motion vector information items are directly encoded, the efficiency of encoding is decreased.

Accordingly, a technique for searching within a decoded image for a region of the image having a high correlation with a decoded image of a template region, which is part of the decoded image and adjacent to the image of a region to be decoded while keeping a predetermined positional relationship, and performing prediction on the basis of the searched region and a predetermined positional relationship has been proposed (refer to PTL 1).

In this method, a decoded image is used for matching. Accordingly, by predetermining a search area, the same process can be performed in an encoding apparatus and a decoding apparatus. That is, by performing the above-described prediction/compensation process in even the decoding apparatus, motion vector information need not be included in the image compression information received from the encoding apparatus. Therefore, a decrease in the encoding efficiency can be prevented.

### Citation List

### Patent Literature

PTL 1: Japanese Unexamined Patent Application Publication No. 2007-43651

### SUMMARY OF INVENTION

### Technical Problem

However, if the technique described in PTL 1 is applied to a prediction/compensation process with sub-pixel accuracy, the prediction performance (the residual error) decreases since the pixel values of a region of an image to be encoded are not used and the number of pixel values used for matching is small. As a result, even though a motion vector is not needed, the encoding efficiency may be decreased.

Accordingly, the present invention is intended to prevent a decrease in the encoding efficiency.

### Solution to Problem

According to an aspect of the present invention, an image processing apparatus includes a decoding unit configured to decode encoded motion vector information, a first motion prediction and compensation unit configured to generate a predicted image with integer-pixel accuracy for a first target block of a frame by searching for a motion vector using a template that is adjacent to the first target block with a predetermined positional relationship and that is generated from a decoded image, and a second motion prediction and compensation unit configured to generate a predicted image with sub-pixel accuracy using sub-pixel accuracy motion vector information regarding the first target block decoded by the decoding unit.

The second motion prediction and compensation unit can generate a predicted value of the sub-pixel accuracy motion vector using the motion vector information regarding a neighboring block that is adjacent to the first target block and that has already been encoded.

The second motion prediction and compensation unit can generate motion vector information regarding a co-located block of an encoded frame different from the frame, where the co-located block is located at a position corresponding to the first target block, and a block that is adjacent to the co-located block or generate a predicted value of the sub-pixel accuracy motion vector using the motion vector information regarding the co-located block and the neighboring block.

The image processing apparatus can further include a third motion prediction and compensation unit configured to search for a motion vector of a second target block of the frame using the second target block, and an image selection unit configured to select one of a predicted image based on the motion vector searched for by the first or second motion prediction and compensation unit and a predicted image based on the motion vector searched for by the third motion prediction and compensation unit.

According to another aspect of the present invention, an image processing method for use in an image processing apparatus is provided. The method includes the steps of decoding encoded motion vector information, generating a predicted image with integer-pixel accuracy for a target block of a frame by searching for a motion vector using a template that is adjacent to the target block with a predetermined positional relationship and that is generated from a decoded image, and generating a predicted image with sub-pixel accuracy using a sub-pixel accuracy motion vector of the decoded target block.

According to another aspect of the present invention, an image processing apparatus includes a first motion prediction and compensation unit configured to search for an integer-pixel accuracy motion vector of a first target block of a frame using a template that is adjacent to the first target block with a predetermined positional relationship and that is generated from a decoded image, a second motion prediction and compensation unit configured to search for a sub-pixel accuracy motion vector of the first target block using the first target block, and an encoding unit configured to encode information regarding the sub-pixel accuracy motion vector searched for by the second motion prediction and compensation unit as information regarding a motion vector of the first target block.

The second motion prediction and compensation unit can generate a predicted value of the sub-pixel accuracy motion vector using the motion vector information regarding a neighboring block that is adjacent to the first target block and that has already been encoded, and the encoding unit can encode a difference between the information regarding the sub-pixel accuracy motion vector and the predicted value as the motion vector information regarding the first target block.

The second motion prediction and compensation unit can generate motion vector information regarding a co-located block of an encoded frame different from the frame, where the co-located block is located at a position corresponding to the first target block, and a block regarding a block that is adjacent to the co-located block or generates the predicted value of the sub-pixel accuracy motion vector using the motion vector information regarding the co-located block and the neighboring block, and the encoding unit encodes a difference between the information regarding the sub-pixel accuracy motion vector and the predicted value as motion vector information regarding the first target block.

When the size of the first target block is a size of 16×16 pixels and if the predicted value of the sub-pixel accuracy motion vector is 0 and all of orthogonal transform coefficients are 0, the encoding unit can encode only a flag indicating that the first target block is a template skip block as the motion vector information regarding the first target block.

The image processing apparatus can further include a third motion prediction and compensation unit configured to search for a motion vector of a second target block of the frame using the second target block and an image selection unit configured to select one of a predicted image based on the motion vector searched for by the first or second motion prediction and compensation unit and a predicted image based on the motion vector searched for by the third motion prediction and compensation unit.

Upon performing arithmetic coding, the encoding unit can define first context for the first target block that is a target of the first and second motion prediction and compensation units and second context for the second target block that is a target of the third motion prediction and compensation unit, and the encoding unit can encode the information regarding the motion vector of the first target block using the first context and encodes the information regarding the motion vector of the second target block using the second context.

Upon performing arithmetic coding, the encoding unit can define one context, and the encoding unit can encode the information regarding the motion vector of the first target block and the information regarding the motion vector of the second target block using the context.

Upon performing arithmetic coding, the encoding unit can define first context for information regarding a motion vector with integer-pixel accuracy and second context for information regarding a sub-pixel accuracy motion vector. The encoding unit can encode the information regarding the sub-pixel accuracy motion vector among information regarding motion vectors of the first target block using the second context, and the encoding unit can encode the information regarding the motion vector with integer-pixel accuracy among information regarding motion vectors of the second target block using the first context and encode the information regarding the motion vector with sub-pixel accuracy using the second context.

According to still another aspect of the present invention, an image processing method for use in an image processing apparatus is provided. The method includes the steps of searching for an integer-pixel accuracy motion vector of a target block of a frame using a template that is adjacent to the target block with a predetermined positional relationship and that is generated from a decoded image, searching for a sub-pixel accuracy motion vector of the target block using the target block, and encoding information regarding the searched sub-pixel accuracy motion vector as information regarding a motion vector of the target block.

According to an aspect of the present invention, encoded motion vector information is decoded. In addition, a predicted image with integer-pixel accuracy for a first target block of a frame is generated by searching for a motion vector using a template that is adjacent to the first target block with a predetermined positional relationship and that is generated from a decoded image, and a predicted image with sub-pixel accuracy is generated by using a sub-pixel accuracy motion vector of the first target block decoded by the decoding unit.

According to another aspect of the present invention, an integer-pixel accuracy motion vector of a target block of a frame is searched for using a template that is adjacent to the target block with a predetermined positional relationship and that is generated from a decoded image. In addition, a sub-pixel accuracy motion vector of the target block is searched for using the target block. Furthermore, information regarding the searched sub-pixel accuracy motion vector is encoded as information regarding a motion vector of the target block.

### Advantageous Effects of Invention

As described above, according to an aspect of the present invention, an image can be decoded. In addition, according to the aspect of the present invention, a decrease in compression efficiency can be prevented.

According to another aspect of the present invention, an image can be encoded. In addition, according to the aspect of the present invention, a decrease in the compression efficiency can be prevented.

### BRIEF DESCRIPTION OF DRAWINGS

FIG. 1 is a block diagram of the configuration of an image encoding apparatus according to an embodiment of the present invention.

FIG. 2 illustrates a variable-length-block motion prediction/compensation process.

FIG. 3 illustrates a motion prediction/compensation process with ¼-pixel accuracy.

FIG. 4 is a block diagram illustrating the configuration of a lossless encoding unit 66 shown in FIG. 1 according to an embodiment.

FIG. 5 illustrates the process performed by a context modeling unit 91 shown in FIG. 4.

FIG. 6 illustrates an example of a table of a binarizing unit 92 shown in FIG. 4.

FIG. 7 is a flowchart illustrating an encoding process performed by the image encoding apparatus shown in FIG. 1.

FIG. 8 is a flowchart illustrating a prediction process performed in step S21 shown in FIG. 7.

FIG. 9 is a flowchart illustrating an intra prediction process performed in step S31 shown in FIG. 8.

FIG. 10 illustrates directions of intra prediction.

FIG. 11 illustrates intra prediction.

FIG. 12 is a flowchart illustrating an inter motion prediction process performed in step S32 shown in FIG. 8.

FIG. 13 illustrates an example of a method for generating motion vector information.

FIG. 14 illustrates another example of a method for generating motion vector information.

FIG. 15 is a flowchart illustrating an inter template motion prediction process performed in step S33 shown in FIG. 8.

FIG. 16 illustrates an inter template matching method.

FIG. 17 is a flowchart illustrating a template skip determination process performed in step S74 shown in FIG. 15.

FIG. 18 is a block diagram of the configuration of an image decoding apparatus according to an embodiment of the present invention.

FIG. 19 is a flowchart illustrating a decoding process performed by the image decoding apparatus shown in FIG. 18.

FIG. 20 is a flowchart illustrating a prediction process performed in step S138 shown in FIG. 19.

### DESCRIPTION OF EMBODIMENTS

Embodiments of the present invention are described below with reference to the accompanying drawings.

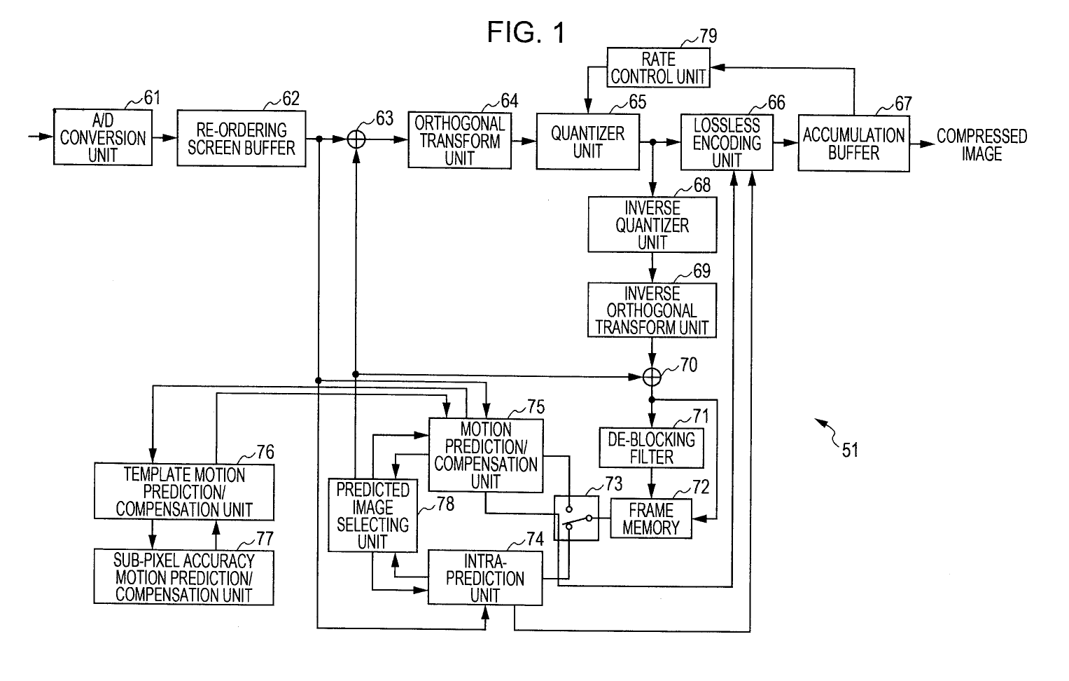

FIG. 1 illustrates the configuration of an image encoding apparatus according to an embodiment of the present invention. An image encoding apparatus 51 includes an A/D conversion unit 61, a re-ordering screen buffer 62, a computing unit 63, an orthogonal transform unit 64, a quantizer unit 65, a lossless encoding unit 66, an accumulation buffer 67, an inverse quantizer unit 68, an inverse orthogonal transform unit 69, a computing unit 70, a de-blocking filter 71, a frame memory 72, a switch 73, an intra prediction unit 74, a motion prediction/compensation unit 75, a template motion prediction/compensation unit 76, a sub-pixel accuracy motion prediction/compensation unit 77, a predicted image selecting unit 78, and a rate control unit 79.

The image encoding apparatus 51 compression-encodes an image using, for example, an H.264 and MPEG-4 Part 10 (Advanced Video Coding) (hereinafter referred to as “H.264/AVC”) standard.

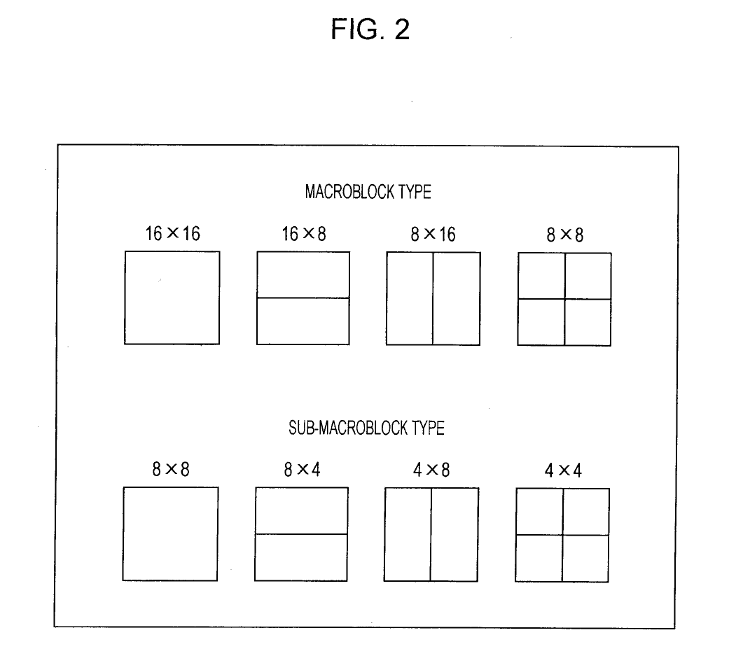

In the H.264/AVC standard, motion prediction/compensation is performed using a variable block size. That is, as shown in FIG. 2, in the H.264/AVC standard, a macroblock including 16×16 pixels is separated into one of 16×16 partitions, 16×8 partitions, 8×16 partitions, and 8×8 partitions. Each of the partitions can have independent motion vector information. In addition, as shown in FIG. 2, an 8×8 partition can be separated into one of an 8×8 sub-partition, 8×4 sub-partitions, 4×8 sub-partitions, and 4×4 sub-partitions. Each of the sub-partitions can have independent motion vector information.

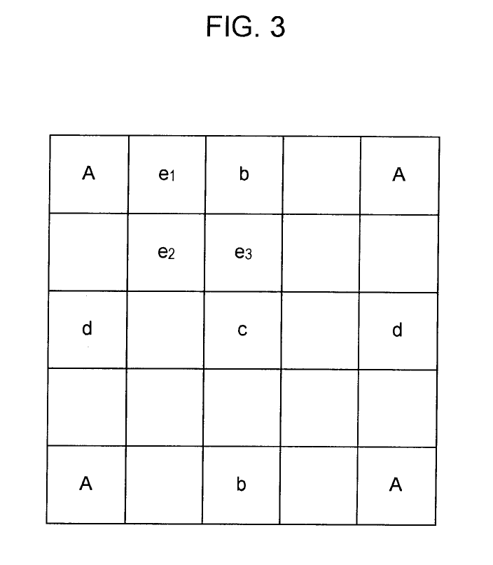

In addition, in the H.264/AVC standard, when a motion prediction and compensation process with ¼-pixel accuracy is performed using a 6-tap FIR (Finite Impulse Response Filter). A prediction/compensation process with sub-pixel accuracy in the H.264/AVC standard is described next with reference to FIG. 3.

In an example shown in FIG. 3, positions A represent the positions of integer accuracy pixels, positions b, c, and d represent the positions of ½-pixel accuracy pixels, and positions e1, e2, and e3 represent the positions of ¼-pixel accuracy pixels. In the following description, Clip( ) is defined first as follows.

$$\begin{matrix}[ Math . 1 ] & \\ Clip 1 ( a ) = \{ \begin{matrix}0 ; & if ( a < 0 ) \\ a ; & otherwise \\ max\_pix ; & if ( a > max\_pix )\end{matrix} & ( 1 )\end{matrix}$$

Note that when an input image is an image with 8-bit accuracy, the value of max_pix is 255.

The pixel values at the position b and d are generated using a 6-tap FIR filter as follows:

[Math. 2]

F=A₋₂−5·A₋₁+20·A₀+20·A₁−5·A₂+A₃

b, d=Clip1((F+16)>>5) (2)

The pixel value at the position c is generated using a 6-tap FIR filter in the horizontal direction and the vertical direction as follows:

[Math. 3]

F=b₋₂−5·b₋₁+20·b₀+20·b₁−5·b₂+b₃

or

F=d₋₂−5·d₋₁+20·d₀+20·d₁−5·d₂+d₃

c=Clip1((F+512)>>10) (3)

Note that after a product-sum operation in the horizontal direction and a product-sum operation in the vertical direction are performed, the Clip process is performed only once.

The positions e1 to e3 are generated using linear interpolation as follows:

[Math. 4]

e₁=(A+b+1)>>1

e₂=(b+d+1)>>1

e₃=(b+c+1)>>1 (4)

Referring back to FIG. 1, the A/D conversion unit 61 A/D-converts an input image and outputs the result into the re-ordering screen buffer 62, which stores the result. Thereafter, the re-ordering screen buffer 62 re-orders, in accordance with the GOP (Group of Picture), the images of frames arranged in the order in which they are stored so that the images are arranged in the order in which the frames are to be encoded.

The computing unit 63 subtracts, from the image read from the re-ordering screen buffer 62, a predicted image that is received from the intra prediction unit 74 and that is selected by the predicted image selecting unit 78 or a predicted image that is received from the motion prediction/compensation unit 75. Thereafter, the computing unit 63 outputs the difference information to the orthogonal transform unit 64. The orthogonal transform unit 64 performs orthogonal transform, such as discrete cosine transform or Karhunen-Loeve transform, on the difference information received from the computing unit 63 and outputs the transform coefficient. The quantizer unit 65 quantizes the transform coefficient output from the orthogonal transform unit 64.

The quantized transform coefficient output from the quantizer unit 65 is input to the lossless encoding unit 66. The lossless encoding unit 66 performs lossless encoding, such as variable-length encoding or arithmetic coding. Thus, the quantized transform coefficient is compressed.

The lossless encoding unit 66 acquires information regarding intra prediction from the intra prediction unit 74 and acquires information regarding inter prediction and inter-template prediction from the motion prediction/compensation unit 75. The lossless encoding unit 66 encodes the quantized transform coefficient. In addition, the lossless encoding unit 66 encodes the information regarding intra prediction and the information regarding inter prediction and inter-template prediction. The encoded information serves as part of header information. The lossless encoding unit 66 supplies the encoded information to the accumulation buffer 67, which accumulates the encoded data.

For example, in the lossless encoding unit 66, a lossless encoding process, such variable length encoding (e.g., CAVLC (Context-Adaptive Variable Length Coding) defined by the H.264/AVC standard) or an arithmetic coding (e.g., CABAC (Context-Adaptive Binary Arithmetic Coding)), is performed. The CABAC encoding method is described below.

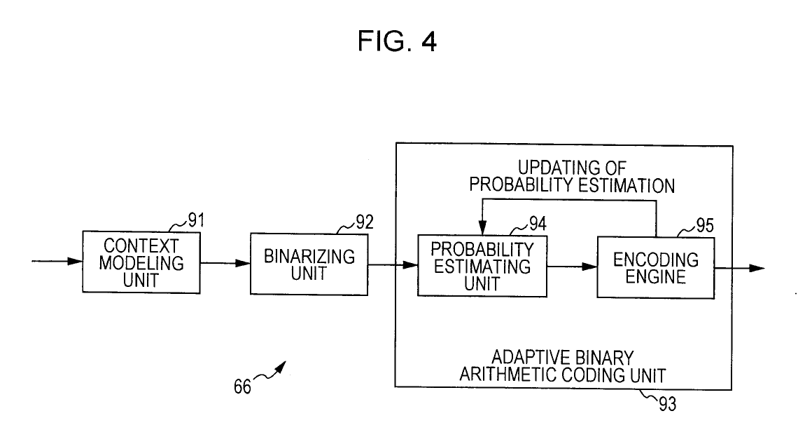

FIG. 4 illustrates an example of the configuration of the lossless encoding unit 66 that performs CABAC encoding. In the example shown in FIG. 4, the lossless encoding unit 66 includes a context modeling unit 91, a binarizing unit 92, and an adaptive binary arithmetic coding unit 93. The adaptive binary arithmetic coding unit 93 includes a probability estimating unit 94 and an encoding engine 95.

Firstly, the context modeling unit 91 converts a symbol of any syntax element of the compressed image into an appropriate context model in accordance with a past history. In the CABAC coding, different syntax elements are encoded using different contexts. In addition, even the same syntax elements are encoded using different contexts in accordance with the encoding information for the nearby block or the macroblock.

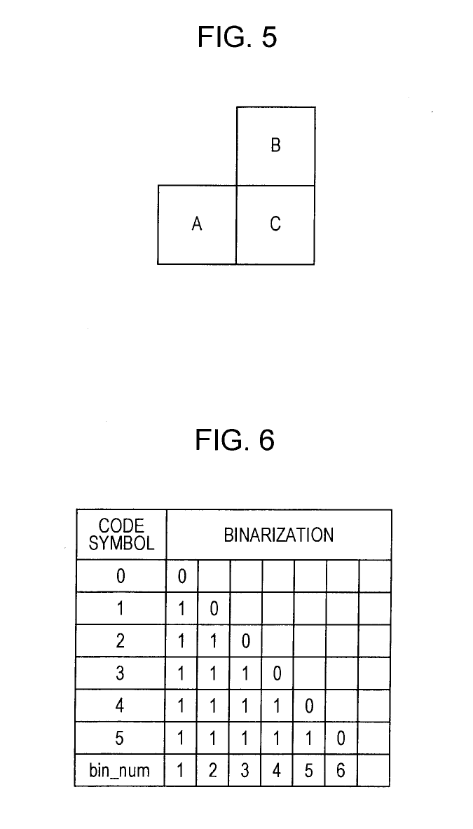

As an example, a process for a flag mb_skip_frag is described next with reference to FIG. 5. However, a process for another syntax element can be performed in a similar manner.

In the example in FIG. 5, a target macroblock C to be encoded next and neighboring macroblocks A and B that have already been encoded and that are adjacent to the target macroblock C are shown. The flag mb_skip_frag is defined for each of the macroblocks X (X=A, B, C) and is expressed as follows.

$$\begin{matrix}[ Math . 5 ] & \\ f ( X ) = \{ \begin{matrix}1 ; & if ( X = skip ) \\ 0 ; & Otherwise\end{matrix} & ( 5 )\end{matrix}$$

That is, if the macroblock X is a skipped macroblock that directly uses pixels of a reference frame at spatially corresponding positions, f(X)=1. Otherwise, f(X)=0.

At that time, the context Context(C) for the target macroblock C is computed as the sum of f(A) of the left neighboring macroblock A and f(B) of the upper neighboring macroblock B as follows:

Context(C)=f(A)+f(B) (6)

That is, the value of the context Context(C) for the target macroblock C is 0, 1, or 2 in accordance with the flags mb_skip_frag of the neighboring macroblocks A and B. The flag mb_skip_frag for the target macroblock C is encoded using the encoding engine 95 for one of 0, 1, and 2.

For example, as in an intra prediction mode, the binarizing unit 92 performs conversion of a symbol of an element, which is non-binary data in the syntax, using a table shown in FIG. 6.

In the table shown in FIG. 6, when a code symbol is 0, the code symbol is binarized into 0. In contrast, when a code symbol is 1, the code symbol is binarized into 10. When a code symbol is 2, the code symbol is binarized into 110. In addition, when a code symbol is 3, the code symbol is binarized into 1110. When a code symbol is 4, the code symbol is binarized into 11110. When a code symbol is 5, the code symbol is binarized into 111110.

However, for a macroblock type, this table is not used. A binarizing process is performed using another defined table.

The syntax element binarized in the above-described manner is encoded by the downstream adaptive binary arithmetic coding unit 93.

In the adaptive binary arithmetic coding unit 93, the probability estimating unit 94 estimates the probability for the binarized symbol, and the encoding engine 95 performs adaptive binary arithmetic coding on the basis of the probability estimation. At that time, the probability of “0” or “1” is initialized at the head of the slice. The probability table is updated each time 1Bin encoding is performed. That is, after the adaptive arithmetic coding process has been performed, the associated model is updated. Accordingly, each model can perform an encoding process in accordance with the statistics of actual image compression information.

Referring back to FIG. 1, the accumulation buffer 67 outputs, to, for example, a downstream recording apparatus or a downstream transmission line (neither is shown), the data supplied from the lossless encoding unit 66 in the form of a compressed image encoded using the H.264/AVC standard. The rate control unit 79 controls a quantizing operation performed by the quantizer unit 65 on the basis of the compressed images accumulated in the accumulation buffer 67.

In addition, the quantized transform coefficient output from the quantizer unit 65 is also input to the inverse quantizer unit 68 and is inverse-quantized. Thereafter, the transform coefficient is subjected to inverse orthogonal transformation in the inverse orthogonal transducer unit 69. The result of the inverse orthogonal transformation is added to the predicted image supplied from the predicted image selecting unit 78 by the computing unit 70. In this way, a locally decoded image is generated. The de-blocking filter 71 removes block distortion of the decoded image and supplies the decoded image to the frame memory 72. Thus, the decoded image is accumulated. In addition, the image before the de-blocking filter process is performed by the de-blocking filter 71 is supplied to the frame memory 72 and is accumulated.

The switch 73 outputs the reference image accumulated in the frame memory 72 to the motion prediction/compensation unit 75 or the intra prediction unit 74.

In the image encoding apparatus 51, for example, an I picture, a B picture, and a P picture received from the re-ordering screen buffer 62 are supplied to the intra prediction unit 74 as an image to be subjected to intra prediction (also referred to as an “intra process”). In addition, a B picture and a P picture read from the re-ordering screen buffer 62 are supplied to the sub-pixel accuracy motion prediction/compensation unit 77 as an image to be subjected to inter prediction (also referred to as an “inter process”).

The intra prediction unit 74 performs an intra prediction process in all of the candidate intra prediction modes using the image to be subjected to intra prediction and read from the re-ordering screen buffer 62 and the reference image supplied from the frame memory 72. Thus, the intra prediction unit 74 generates a predicted image.

At that time, the intra prediction unit 74 computes a cost function value for each of the candidate intra prediction modes and selects the intra prediction mode that minimizes the computed cost function value as an optimal intra prediction mode.

The intra prediction unit 74 supplies the predicted image generated in the optimal intra prediction mode and the cost function value of the optimal intra prediction mode to the predicted image selecting unit 78. When the predicted image generated in the optimal intra prediction mode is selected by the predicted image selecting unit 78, the intra prediction unit 74 supplies information regarding the optimal intra prediction mode to the lossless encoding unit 66. The lossless encoding unit 66 encodes the information and uses the information as part of the header information.

The motion prediction/compensation unit 75 performs a motion prediction/compensation process for each of the candidate inter prediction modes. That is, the motion prediction/compensation unit 75 detects a motion vector in each of the candidate inter prediction modes on the basis of the image to be subjected to inter process and read from the re-ordering screen buffer 62 and the reference image supplied from the frame memory 72 via the switch 73. Thereafter, the motion prediction/compensation unit 75 performs motion prediction/compensation on the reference image on the basis of the motion vectors and generates a predicted image.

In addition, the motion prediction/compensation unit 75 supplies, to the template motion prediction/compensation unit 76, the image to be subjected to inter process and read from the re-ordering screen buffer 62 and the reference image supplied from the frame memory 72 via the switch 73.

Furthermore, the motion prediction/compensation unit 75 computes a cost function value for each of the candidate inter prediction modes. The motion prediction/compensation unit 75 selects, as an optimal inter prediction mode, the prediction mode that minimizes the cost function value from among the cost function values computed for the inter prediction modes and the cost function values computed for the inter template prediction modes by the template motion prediction/compensation unit 76.

The motion prediction/compensation unit 75 supplies the predicted image generated in the optimal inter prediction mode and the cost function value of the predicted image to the predicted image selecting unit 78. When the predicted image generated by the predicted image selecting unit 78 in the optimal inter prediction mode is selected, the motion prediction/compensation unit 75 supplies, to the lossless encoding unit 66, information regarding the optimal inter prediction mode and information associated with the optimal inter prediction mode (e.g., the motion vector information, the flag information, and the reference frame information). The lossless encoding unit 66 also performs a lossless encoding process, such as variable-length encoding or an arithmetic coding, on the information received from the motion prediction/compensation unit 75 and inserts the information into the header portion of the compressed image.

The template motion prediction/compensation unit 76 and the sub-pixel accuracy motion prediction/compensation unit 77 perform motion prediction/compensation in the inter template prediction mode. The template motion prediction/compensation unit 76 performs motion prediction and compensation on an integer pixel basis. The sub-pixel accuracy motion prediction/compensation unit 77 performs motion prediction and compensation on a sub-pixel basis.

That is, the template motion prediction/compensation unit 76 performs motion prediction and compensation in an inter template prediction mode on an integer pixel basis using the image to be subjected to inter process and read from the re-ordering screen buffer 62 and the reference image supplied from the frame memory 72 via the switch 73. Thus, the template motion prediction/compensation unit 76 generates a predicted image.

In addition, the template motion prediction/compensation unit 76 supplies, to the sub-pixel accuracy motion prediction/compensation unit 77, the image read from the re-ordering screen buffer 62 and to be inter coded and the reference image supplied from the frame memory 72 via the switch 73.

The template motion prediction/compensation unit 76 computes a cost function value for the inter template prediction mode and supplies the computed cost function value and the predicted image to the motion prediction/compensation unit 75. If information associated with the inter template prediction mode (e.g., the motion vector information and the flag information) is present, the information is also supplied to the motion prediction/compensation unit 75.

The sub-pixel accuracy motion prediction/compensation unit 77 performs motion prediction and compensation in an inter template prediction mode on a sub-pixel basis using the image to be subjected to an inter process and read from the re-ordering screen buffer 62 and the reference image supplied from the frame memory 72 via the switch 73. Thus, the sub-pixel accuracy motion prediction/compensation unit 77 generates a predicted image. The sub-pixel accuracy motion prediction/compensation unit 77 supplies the generated predicted image and one of the motion vector information and the flag information to the template motion prediction/compensation unit 76.

The predicted image selecting unit 78 determines an optimal prediction mode from among the optimal intra prediction mode and the optimal inter prediction mode on the basis of the cost function values output from the intra prediction unit 74 or the motion prediction/compensation unit 75. Thereafter, the predicted image selecting unit 78 selects the predicted image in the determined optimal prediction mode and supplies the predicted image to the computing units 63 and 70. At that time, the predicted image selecting unit 78 supplies selection information regarding the predicted image to the intra prediction unit 74 or the motion prediction/compensation unit 75.

The rate control unit 79 controls the rate of the quantization operation performed by the quantizer unit 65 on the basis of the compressed images accumulated in the accumulation buffer 67 so that overflow and underflow does not occur.

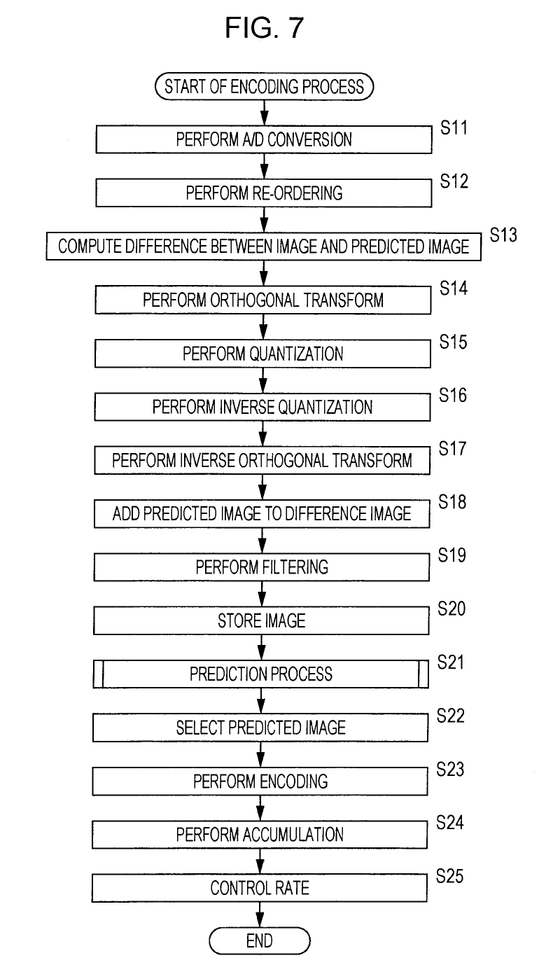

The encoding process performed by the image encoding apparatus 51 shown in FIG. 1 is described next with reference to a flowchart shown in FIG. 7.

In step S11, the A/D conversion unit 61 A/D-converts an input image. In step S12, the re-ordering screen buffer 62 stores the images supplied from the A/D conversion unit 61 and converts the order in which pictures are displayed into the order in which the pictures are to be encoded.

In step S13, the computing unit 63 computes the difference between the image re-ordered in step S12 and the predicted image. The predicted image is supplied from the motion prediction/compensation unit 75 in the case of inter prediction and is supplied from the intra prediction unit 74 in the case of intra prediction to the computing unit 63 via the predicted image selecting unit 78.

The data size of the difference data is smaller than that of the original image data. Accordingly, the data size can be reduced, as compared with the case in which the image is directly encoded.

In step S14, the orthogonal transform unit 64 performs orthogonal transform on the difference information supplied from the computing unit 63. More specifically, orthogonal transform, such as discrete cosine transform or Karhunen-Loeve transform, is performed, and a transform coefficient is output. In step S15, the quantizer unit 65 quantizes the transform coefficient. As described in more detail below with reference to a process performed in step S25, the rate is controlled in this quantization process.

The difference information quantized in the above-described manner is locally decoded as follows. That is, in step S16, the inverse quantizer unit 68 inverse quantizes the transform coefficient quantized by the quantizer unit 65 using a characteristic that is the reverse of the characteristic of the quantizer unit 65. In step S17, the inverse orthogonal transform unit 69 performs inverse orthogonal transform on the transform coefficient inverse quantized by the inverse quantizer unit 68 using the characteristic corresponding to the characteristic of the orthogonal transform unit 64.

In step S18, the computing unit 70 adds the predicted image input via the predicted image selecting unit 78 to the locally decoded difference image. Thus, the computing unit 70 generates a locally decoded image (an image corresponding to the input of the computing unit 63). In step S19, the de-blocking filter 71 performs filtering on the image output from the computing unit 70. In this way, block distortion is removed. In step S20, the frame memory 72 stores the filtered image. Note that the image that is not subjected to the filtering process performed by the de-blocking filter 71 is also supplied to the frame memory 72 and is stored in the frame memory 72.

In step S21, the intra prediction unit 74, each of the motion prediction/compensation unit 75, the template motion prediction/compensation unit 76, and the sub-pixel accuracy motion prediction/compensation unit 77 performs its own image prediction process. That is, in step S21, the intra prediction unit 74 performs an intra prediction process in the intra prediction mode. The motion prediction/compensation unit 75 performs a motion prediction/compensation process in the inter prediction mode. In addition, the template motion prediction/compensation unit 76 and the sub-pixel accuracy motion prediction/compensation unit 77 perform a motion prediction/compensation process in the inter template prediction mode.

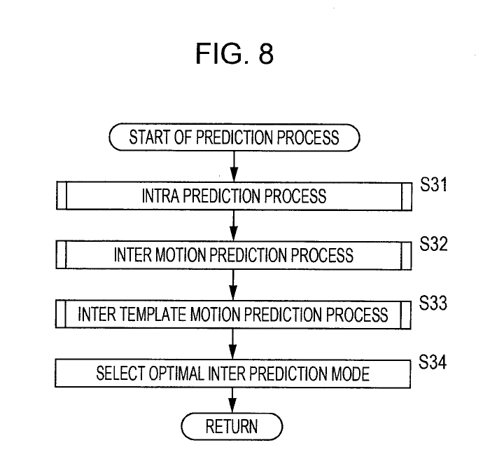

The prediction process performed in step S21 is described in more detail below with reference to FIG. 8. Through the prediction process performed in step S21, the prediction process in each of the candidate prediction modes is performed, and the cost function values for all of the candidate prediction modes are computed. Thereafter, the optimal intra prediction mode is selected on the basis of the computed cost function values, and a predicted image generated using intra prediction in the optimal intra prediction mode and the cost function value of the predicted image are supplied to the predicted image selecting unit 78. In addition, the optimal inter prediction mode is determined from among the inter prediction modes and the inter template prediction modes using the computed cost function values. Thereafter, a predicted image generated in the optimal inter prediction mode and the cost function value of the predicted image are supplied to the predicted image selecting unit 78.

In step S22, the predicted image selecting unit 78 selects one of the optimal intra prediction mode and the optimal inter prediction mode as an optimal prediction mode using the cost function values output from the intra prediction unit 74 and the motion prediction/compensation unit 75. Thereafter, the predicted image selecting unit 78 selects the predicted image in the determined optimal prediction mode and supplies the predicted image to the computing units 63 and 70. As described above, this predicted image is used for the computation performed in steps S13 and S18.

Note that the selection information regarding the predicted image is supplied to the intra prediction unit 74 or the motion prediction/compensation unit 75. When the predicted image in the optimal intra prediction mode is selected, the intra prediction unit 74 supplies information regarding the optimal intra prediction mode (i.e., the intra prediction mode information) to the lossless encoding unit 66.

When the predicted image in the optimal inter prediction mode is selected, the motion prediction/compensation unit 75 supplies information regarding the optimal inter prediction mode and information associated with the optimal inter prediction mode (e.g., the motion vector information, the flag information, and the reference frame information) to the lossless encoding unit 66. More specifically, when the predicted image in the inter prediction mode is selected as the optimal inter prediction mode, the motion prediction/compensation unit 75 outputs the inter prediction mode information, the motion vector information, and the reference frame information to the lossless encoding unit 66.

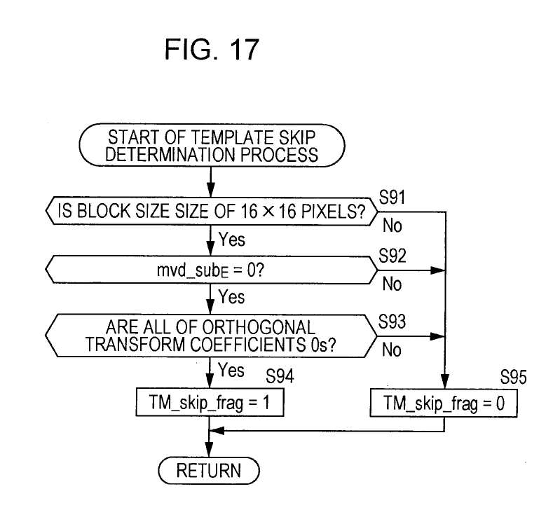

In contrast, when the predicted image in the inter template prediction mode is selected as the optimal inter prediction mode, the motion prediction/compensation unit 75 supplies the inter template prediction mode information, the motion vector information, and the sub-pixel-based motion vector information to the lossless encoding unit 66. Note that at that time, if it is determined that the target block indicates template skip, flag information indicating template matching skipping (described below with reference to FIG. 17) (TM_skip_frag=1) is output in place of the sub-pixel-based motion vector information.

In step S23, the lossless encoding unit 66 encodes the quantized transform coefficient output from the quantizer unit 65. That is, the difference image is lossless encoded (e.g., variable-length encoded or arithmetic encoded) and is compressed. At that time, the above-described intra prediction mode information input from the intra prediction unit 74 to the lossless encoding unit 66 or the above-described information associated with the optimal inter prediction mode (e.g., the prediction mode information, the motion vector information, and the reference frame information) input from the motion prediction/compensation unit 75 to the lossless encoding unit 66 in step S22 is also encoded and is added to the header information.

Note that if flag information indicating template matching skipping is output from the motion prediction/compensation unit 75, only the flag information is encoded. That is, even a transform coefficient is not encoded.

In this case, in the lossless encoding unit 66, if the lossless coding method is based on the CABAC described above with reference to FIG. 4, the context of the target block for the inter template prediction mode can be defined separately from the context defined for the inter prediction mode and the intra prediction mode. Alternatively, the context that is the same as the context for the inter prediction mode and the intra prediction mode can be used.

Still alternatively, the context for the integer pixel accuracy motion vector information and the context for the sub-pixel accuracy motion vector information can be separately defined, and encoding can be performed using the contexts.

That is, in this case, among the motion vectors obtained through the prediction process in the inter prediction mode, the integer pixel accuracy motion vector information is encoded using the context for the integer pixel accuracy motion vector information. In contrast, among the motion vectors obtained through the prediction process in the inter prediction mode, the sub-pixel accuracy motion vector information and the sub-pixel accuracy motion vector information searched for through the prediction process in the inter template prediction mode are encoded using the context for the sub-pixel accuracy motion vector information.

In step S24, the accumulation buffer 67 stores the difference image as a compressed image. The compressed image accumulated in the accumulation buffer 67 is read as needed and is transferred to the decoding side via a transmission line.

In step S25, the rate control unit 79 controls the rate of the quantization operation performed by the quantizer unit 65 on the basis of the compressed images stored in the accumulation buffer 67 so that overflow and underflow do not occur.

The prediction process performed in step S21 shown in FIG. 7 is described next with reference to a flowchart shown in FIG. 8.

If each of the images supplied from the re-ordering screen buffer 62 and to be processed is an image of a block to be intra processed, the decoded image to be referenced is read from the frame memory 72 and is supplied to the intra prediction unit 74 via the switch 73. In step S31, the intra prediction unit 74 performs, using the images, intra prediction on a pixel of the block to be processed in all of the candidate intra prediction modes. Note that the pixel that is not subjected to deblock filtering performed by the de-blocking filter 71 is used as the decoded pixel to be referenced.

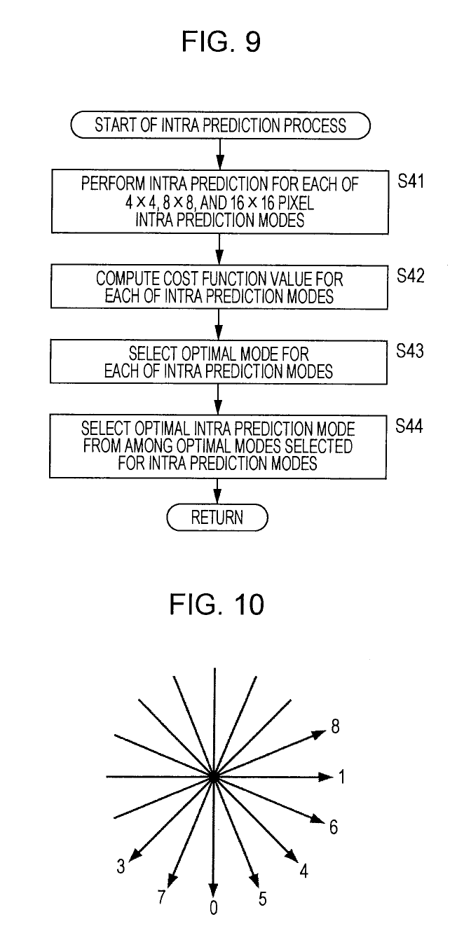

The intra prediction process performed in step S31 is described below with reference to FIG. 9. Through the intra prediction process, intra prediction is performed in all of the candidate intra prediction modes, and the cost function values for all of the candidate intra prediction modes are computed. Thereafter, an optimal intra prediction mode is selected on the basis of the computed cost function values. A predicted image generated through intra prediction in the optimal intra prediction mode and the cost function value thereof are supplied to the predicted image selecting unit 78.

If each of the images supplied from the re-ordering screen buffer 62 and to be processed is an image of a block to be subjected to the inter process, an image to be referenced is read from the frame memory 72 and is supplied to the motion prediction/compensation unit 75 via the switch 73. In step S32, the motion prediction/compensation unit 75 performs, using the images, an inter motion prediction process. That is, the motion prediction/compensation unit 75 references the images supplied from the frame memory 72 and performs a motion prediction process in all of the candidate inter prediction modes.

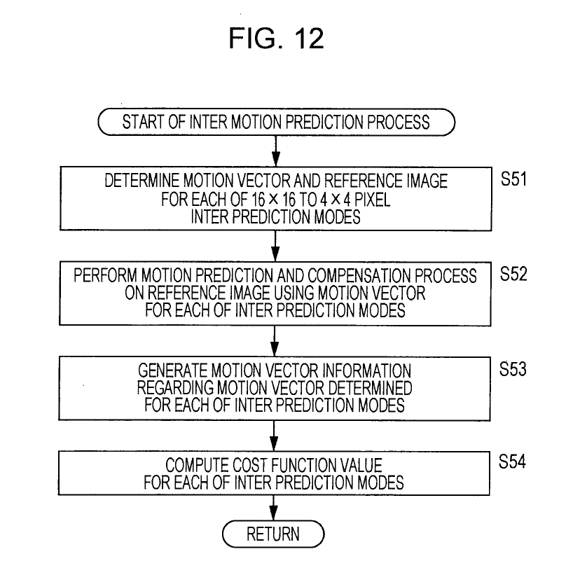

The inter motion prediction process performed in step S32 is described in more detail below with reference to FIG. 12. Through the inter motion prediction process, a motion prediction process is performed in all of the candidate inter prediction modes, and cost function values for all of the candidate inter prediction modes are computed.

In addition, if each of the images supplied from the re-ordering screen buffer 62 and to be processed is an image of a block to be subjected to the inter process, an image to be referenced is read from the frame memory 72 and is also supplied to the template motion prediction/compensation unit 76 via the switch 73 and the motion prediction/compensation unit 75. In step S33, the template motion prediction/compensation unit 76 and the sub-pixel accuracy motion prediction/compensation unit 77 perform, using the images, an inter template motion prediction process in the inter template prediction mode.

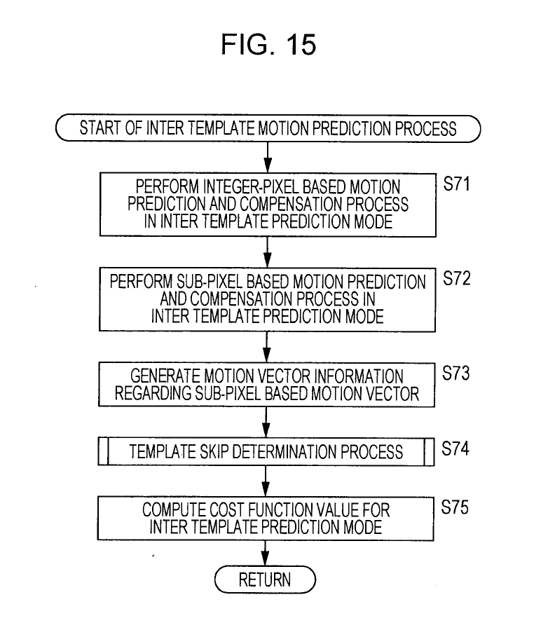

The inter template motion prediction process performed in step S33 is described in more detail below with reference to FIG. 15. Through the inter template motion prediction process, a motion prediction process is performed in the inter template prediction mode, and a cost function value for the inter template prediction mode is computed. Thereafter, the predicted image generated through the motion prediction process in the inter template prediction mode and the cost function value thereof are supplied to the motion prediction/compensation unit 75. Note that if information associated with the inter template prediction mode (e.g., the motion vector information and the flag information) is present, such information is also supplied to the motion prediction/compensation unit 75.

In step S34, the motion prediction/compensation unit 75 compares the cost function value for the inter prediction mode computed in step S32 with the cost function value for the inter template prediction mode computed in step S33. Thus, the prediction mode that provides the minimum cost function value is selected as an optimal inter prediction mode. Thereafter, the motion prediction/compensation unit 75 supplies a predicted image generated in the optimal inter prediction mode and the cost function value thereof to the predicted image selecting unit 78.

The intra prediction process performed in step S31 shown in FIG. 8 is described next with reference to a flowchart shown in FIG. 9. Note that an example illustrated in FIG. 9 is described with reference to a luminance signal.

In step S41, the intra prediction unit 74 performs intra prediction for 4×4 pixels, 8×8 pixels, and 16×16 pixels in the intra prediction mode.

The intra prediction mode of a luminance signal includes prediction modes based on 9 types of 4×4 pixel blocks and 8×8 pixel blocks and 4 types of 16×16 pixel macroblocks. In contrast, the intra prediction mode of a color difference signal includes prediction modes based on 4 types of 8×8 pixel blocks. The intra prediction mode of a color difference signal can be set independently from the intra prediction mode of a luminance signal. For the 4×4 pixel and 8×8 pixel intra prediction modes of a luminance signal, an intra prediction mode can be defined for each of the 4×4 pixel and 8×8 pixel blocks of a luminance signal. For the 16×16 pixel intra prediction mode of a luminance signal and the intra prediction mode of a color difference signal, an intra prediction mode can be defined for one macroblock.

The types of the prediction mode correspond to the directions indicated by the numbers “0”, “1”, and “3” to “8” shown in FIG. 10. The prediction mode “2” represents an average value prediction.

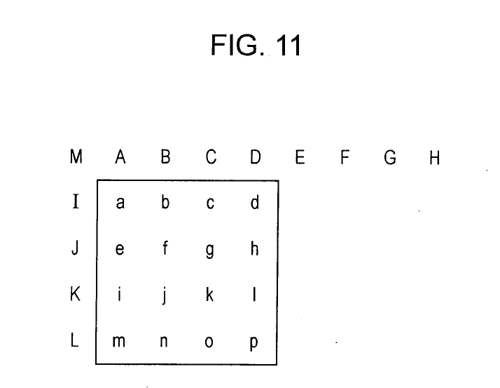

For example, the intra 4×4 prediction mode is described with reference to FIG. 11. When an image to be processed and read from the re-ordering screen buffer 62 (e.g., pixels a to p) is the image of a block to be intra processed, a decoded image to be referenced (pixels A to M) is read from the frame memory 72. Thereafter, the readout image is supplied to the intra prediction unit 74 via the switch 73.

The intra prediction unit 74 performs intra prediction on the pixels of the block to be processed using these images. Such an intra prediction process is performed for each of the intra prediction modes and, therefore, a predicted image for each of the intra prediction modes is generated. Note that pixels that are not subjected to deblock filtering performed by the de-blocking filter 71 are used as the decoded pixels to be referenced (the pixels A to M).

In step S42, the intra prediction unit 74 computes the cost function values for each of 4×4 pixel, 8×8 pixel, and 16×16 pixel intra prediction modes. At that time, the computation of the cost function values is performed using one of the methods of a High Complexity mode and a Low Complexity mode as defined in the JM (Joint Model), which is H.264/AVC reference software.

That is, in the High Complexity mode, the processes up to the encoding process are performed for all of the candidate prediction modes as a process performed in step S41. Thus, a cost function value defined by the following equation (7) is computed for each of the prediction modes and, thereafter, the prediction mode that provides a minimum cost function value is selected as an optimal prediction mode.

Cost(Mode)=D+λ·R (7)

where D denotes the difference (distortion) between the original image and the decoded image, R denotes an amount of generated code including up to the orthogonal transform coefficient, and λ denotes the Lagrange multiplier in the form of a function of a quantization parameter QP.

In contrast, in the Low Complexity mode, generation of a predicted image and computation of the motion vector information, prediction mode information, and the header bit of the flag information are performed for all of the candidate prediction modes as a process performed in step S41. Thus, the cost function value expressed in the following equation (8) is computed for each of the prediction modes and, thereafter, the prediction mode that provides a minimum cost function value is selected as an optimal prediction mode.

Cost(Mode)=D+QPtoQuant(QP)·Header_Bit (8)

where D denotes the difference (distortion) between the original image and the decoded image, Header_Bit denotes a header bit for the prediction mode, and QPtoQuant denotes a function provided in the form of a function of a quantization parameter QP.

In the Low Complexity mode, only a predicted image is generated for each of the prediction mode. An encoding process and a decoding process need not be performed. Accordingly, the amount of computation can be reduced.

In step S43, the intra prediction unit 74 determines an optimal mode for each of the 4×4 pixel, 8×8 pixel, and 16×16 pixel intra prediction modes. That is, as described above with reference to FIG. 10, in the case of the 4×4 pixel and 8×8 pixel intra prediction modes, there are nine types of prediction mode. In the case of the 16×16 pixel intra prediction mode, there are four types of prediction modes. Accordingly, from among these prediction modes, the intra prediction unit 74 selects the optimal 4×4 pixel intra prediction mode, the optimal 8×8 pixel intra prediction mode, and the optimal 16×16 pixel intra prediction mode on the basis of the cost function values computed in step S42.

In step S44, from among the optimal modes selected for the 4×4 pixel, 8×8 pixel, and the 16×16 pixel intra prediction modes, the intra prediction unit 74 selects the optimal intra prediction mode on the basis of the cost function values computed in step S42. That is, from among the optimal modes selected for the 4×4 pixel, 8×8 pixel, and the 16×16 pixel intra prediction modes, the intra prediction unit 74 selects the mode having the minimum cost function value as the optimal intra prediction mode. Thereafter, the intra prediction unit 74 supplies the predicted image generated in the optimal intra prediction mode and the cost function value thereof to the predicted image selecting unit 78.

The inter motion prediction process performed in step S32 shown in FIG. 8 is described next with reference to a flowchart shown in FIG. 12.

In step S51, the motion prediction/compensation unit 75 determines the motion vector and the reference image for each of the eight 16×16 pixel to 4×4 pixel inter prediction modes illustrated in FIG. 2. That is, the motion vector and the reference image are determined for a block to be processed for each of the inter prediction modes.

In step S52, the motion prediction/compensation unit 75 performs a motion prediction and compensation process on the reference image for each of the eight 16×16 pixel to 4×4 pixel inter prediction modes on the basis of the motion vector determined in step S51. Through the motion prediction and compensation process, a predicted image is generated for each of the inter prediction modes.

In step S53, the motion prediction/compensation unit 75 generates motion vector information to be added to the compression image for the motion vector determined for each of the eight 16×16 pixel to 4×4 pixel inter prediction modes.

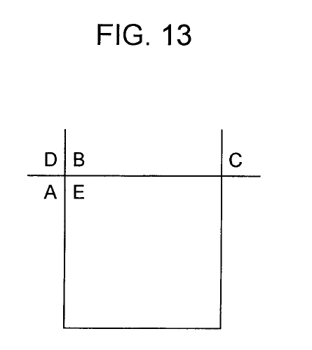

A method for generating the motion vector information in the H.264/AVC standard is described next with reference to FIG. 13. In the example shown in FIG. 13, a target block E to be encoded next (e.g., a 16×16 pixels) and blocks A to D that have already been encoded and that are adjacent to the target block E are shown.

That is, the block D is adjacent to the upper left corner of the target block E. The block B is adjacent to the upper end of the target block E. The block C is adjacent to the upper right corner of the target block E.

The block A is adjacent to the left end of the target block E. Note that the entirety of each of the blocks A to D is not shown, since the blocks A to D is one of 16×16 pixel to 4×4 pixel blocks illustrated in FIG. 2.

For example, let mvₓ denote motion vector information for X (=A, B, C, D, E). Prediction motion vector information pmv_{E} for the target block E is expressed using the motion vector information for the blocks A, B, and C and median prediction as follows.

pmv_{E}=med(mv_{A},mv_{B},mv_{c}) (9)

If the motion vector information regarding the block C is unavailable because, for example, the block C is located at the end of the image frame or the block C has not yet been encoded, the motion vector information regarding the block D is used in place of the motion vector information regarding the block C.

Data mvd_{E} to be added to the header portion of the compressed image as the motion vector information regarding the target block E is given using pmv_{E} as follows:

mvd_{E}=mv_{E}−pmv_{E} (10)

Note that in practice, the process is independently performed for a horizontal-direction component and a vertical-direction component of the motion vector information.

In this way, the prediction motion vector information is generated, and a difference between the prediction motion vector information generated using a correlation between neighboring blocks and the motion vector information is added to the header portion of the compressed image. Thus, the motion vector information can be reduced.

The motion vector information generated in the above-described manner is also used for computation of the cost function value performed in the subsequent step S54. If the predicted image corresponding to the motion vector information is selected by the predicted image selecting unit 78, the motion vector information is output to the lossless encoding unit 66 together with the prediction mode information and the reference frame information.

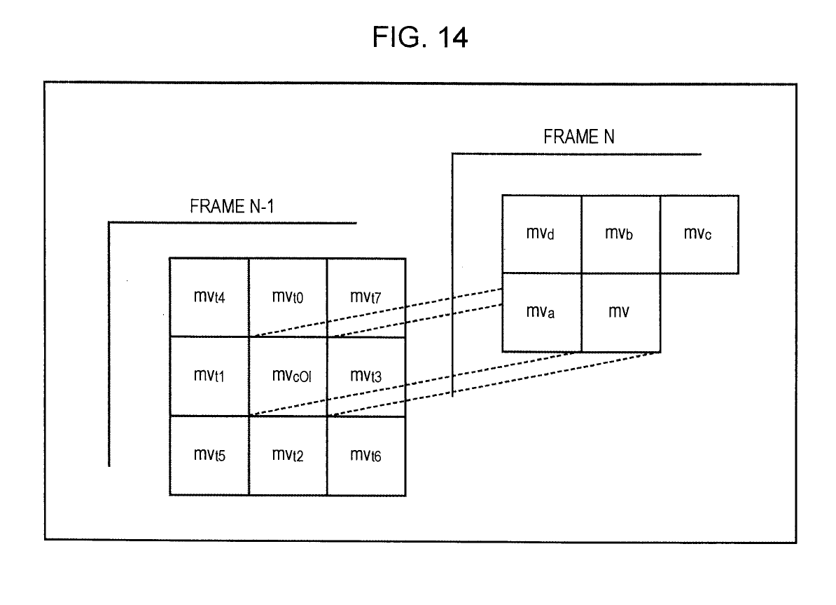

In addition, another method for generating the prediction motion vector information is described next with reference to FIG. 14. In the example shown in FIG. 14, a frame N which is a target frame to be encoded and a frame N-1 which is a reference frame referenced when a motion vector is searched for are shown.

In the frame N, a target block to be encoded next has motion vector information my as shown in FIG. 14. The blocks adjacent to the target block have motion vector information mvₐ, mv_{b}, mv_{c}, and mv_{d} as shown in FIG. 14.

More specifically, the block adjacent to the upper left corner of the target block has the motion vector information mv_{d}. The block adjacent to the upper end of the target block has the motion vector information mv_{b}. The block adjacent to the upper right corner of the target block has the motion vector information mv_{c}. The block adjacent to the left end of the target block has the motion vector information mvₐ.

In the frame N-1, a co-located block of the target block has motion vector information mv_{col} as shown in FIG. 14. As used herein, the term “co-located block” refers to a block of an encoded frame different from the target frame (i.e., a frame located preceding or succeeding to the target frame), the block being located at a position corresponding to the target block.

In addition, in the frame N-1, the blocks adjacent to the target block have motion vector information mvₜ₄, mvₜ₀, mvₜ₇, mvₜ₁, mvₜ₃, mvₜ₅, mvₜ₂, and mvₜ₆ as shown in FIG. 14.

More specifically, the block adjacent to the upper left corner of the co-located block has the motion vector information mvₜ₄. The block adjacent to the upper end of the co-located block has the motion vector information mvₜ₀. The block adjacent to the upper right corner of the co-located block has the motion vector information mvₜ₇. The block adjacent to the left end of the co-located block has the motion vector information mvₜ₁. The block adjacent to the right end of the co-located block has the motion vector information mvₜ₃. The block adjacent to the lower left corner of the co-located block has the motion vector information mvₜ₅. The block adjacent to the lower end of the co-located block has the motion vector information mvₜ₂. The block adjacent to the lower right corner of the co-located block has the motion vector information mvₜ₆.

The prediction motion vector information pmv in equation (9) is generated using the motion vector information regarding the blocks adjacent to the target block. However, the prediction motion vector information pmvₜₘ₅, pmvₜₘ₉, and pmv_{col} can be generated as follows.

pmvₜₘ₅=med(mv_{col},mvₜ₀, . . . ,mvₜ₃)

pmvₜₘ₉=med(mv_{col},mvₜ₀, . . . ,mvₜ₇)

pmv_{col}=med(mv_{col},mv_{col},mvₐ,mv_{b},mv_{c}) (11)

Which one of the prediction motion vector information of equation (9) or equation (11) is used is determined by R-D optimization. Here, R represents an amount of generated code including up to the orthogonal transform coefficient, and D represents the difference between the original image and the decoded image (i.e., distortion). That is, the prediction motion vector information that optimizes the amount of generated code and the difference between the original image and the decoded image is selected.

A method for generating a plurality of prediction motion vector information items and selecting the optimal one from among the generated prediction motion vector information items is also referred to as an “MV Competition method”.

Referring back to FIG. 12, in step S54, the motion prediction/compensation unit 75 computes the cost function value for each of the eight 16×16 pixel to 4×4 pixel inter prediction modes using equation (7) or (8). The computed cost function values here are used for selecting the optimal inter prediction mode in step S34 shown in FIG. 8 as described above.

The inter template motion prediction process performed in step S33 shown in FIG. 8 is described with reference to a flowchart shown in FIG. 15.

In step S71, the template motion prediction/compensation unit 76 performs a motion prediction/compensation process on an integer pixel basis in the inter template prediction mode. That is, the template motion prediction/compensation unit 76 searches for a motion vector on an integer pixel basis using an inter template matching method and performs a motion prediction/compensation process on the basis of the motion vector. In this way, the template motion prediction/compensation unit 76 generates a predicted image.

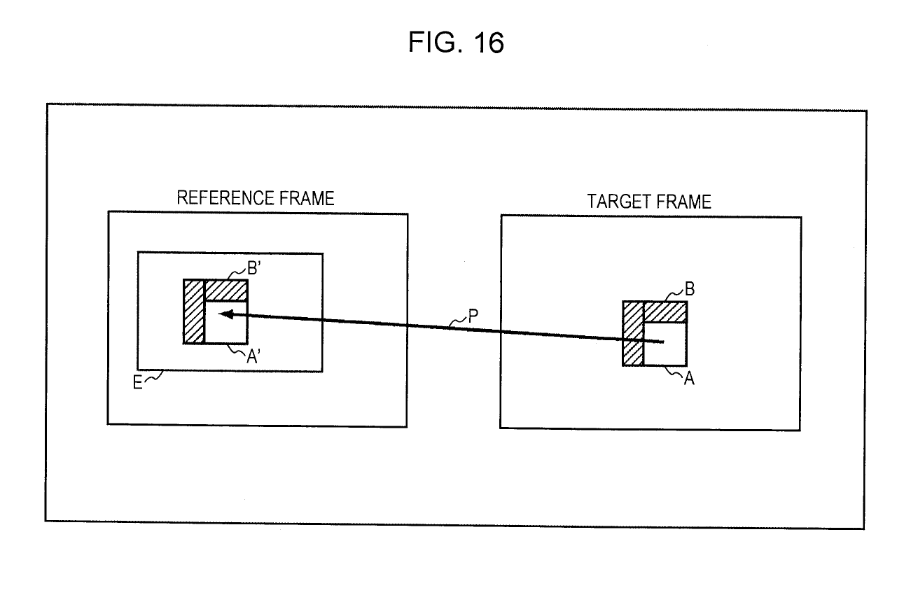

Here, the inter template matching method is described in more detail with reference to FIG. 16.

In the example shown in FIG. 16, a target frame to be encoded and a reference frame referenced when a motion vector is searched for are shown. In the target frame, a target block A to be encoded next and a template region B including pixels that are adjacent to the target block A and that have already been encoded are shown. That is, as shown in FIG. 16, when an encoding process is performed in the raster scan order, the template region B is located on the left of the target block A and on the upper side of the target block A. In addition, the decoded image of the template region B is stored in the frame memory 72.

The template motion prediction/compensation unit 76 performs a template matching process in a predetermined search area E in the reference frame using, for example, SAD (Sum of Absolute Difference) as a cost function value. The template motion prediction/compensation unit 76 searches for a region B′ having the highest correlation with the pixel values of the template region B. Thereafter, the template motion prediction/compensation unit 76 considers a block A′ corresponding to the searched region B′ as a predicted image for the target block A and searches for a motion vector P for the target block A.

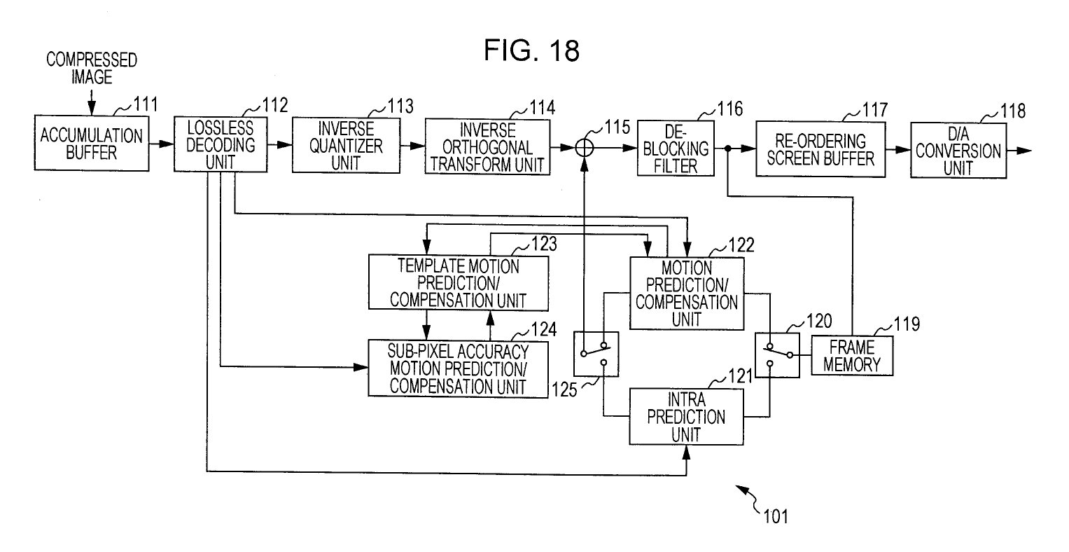

In this way, in the motion vector search process using the inter template matching method, a decoded image is used for the template matching process. Accordingly, by predefining the predetermined search area E, the same process can be performed in the image encoding apparatus 51 shown in FIG. 1 and an image decoding apparatus 101 shown in FIG. 18 (described below). That is, by providing a template motion prediction/compensation unit 123 in the image decoding apparatus 101 as well, information regarding the motion vector P for the target block A need not be sent to the image decoding apparatus 101. Therefore, the motion vector information in a compressed image can be reduced.

Note that any sizes of a block and a template can be employed in the inter template prediction mode. That is, as in the motion prediction/compensation unit 75, from among the eight 16×16 pixel to 4×4 pixel block sizes illustrated in FIG. 2, one block size may be selected, and the process may be performed using the block size at all times. Alternatively, the process may be performed using all the block sizes as candidates. The template size may be changed in accordance with the block size or may be fixed to one size.

In step S72, the template motion prediction/compensation unit 76 instructs the sub-pixel accuracy motion prediction/compensation unit 77 to perform a motion prediction/compensation process on a sub-pixel basis in the inter template prediction mode.

As described above with reference to FIG. 3, in the H.264/AVC standard, a prediction/compensation process up to ¼-pixel accuracy can be performed. However, even in a sub-pixel mode, if a motion vector search process is performed using the inter template matching method, the prediction performance (residual difference) is degraded, since the pixel values of the target block A (FIG. 16) are not used and the search area E is predetermined.

Accordingly, in the inter template prediction mode, a motion prediction/compensation process on a sub-pixel basis is performed using a method such as a block matching method, not the inter template matching method.

That is, in step S72, the sub-pixel accuracy motion prediction/compensation unit 77 searches for a sub-pixel based motion vector using, for example, a block matching method, performs a motion prediction and compensation process on the reference image using the motion vector, and generates a predicted image. At that time, the sub-pixel based motion vector information needs to be added to the header portion of the compressed image. Accordingly, the sub-pixel accuracy motion prediction/compensation unit 77, in step S73, generates motion vector information regarding the sub-pixel based motion vector.

A method for generating the sub-pixel based motion vector information is described with reference to FIG. 13 again. In FIG. 13, a target block E to be subjected to a motion prediction/compensation process next using a template matching method and blocks A to D that are adjacent to the target block E and that have already been encoded are shown. For the target block E, encoding of only sub-pixel based motion vector information mv_sub_{E} among the motion vector information mv_{E} for the block E is sufficient.

At that time, the blocks A to D may not be subjected to a motion prediction/compensation process using a template matching method. However, as long as the blocks A to D are to be subjected to an inter process, the blocks A to D have motion vectors mv_{X} (X=A, B, C, or D). The sub-pixel based motion vector information for each of the blocks A to D is referred to as mv_sub_{X} (X=A, B, C, or D).

Note that if one of the bocks A to D is a block to be subjected to an intra process, the block does not have motion vector information. Accordingly, the block is processed in accordance with the H.264/AVC standard. That is, if the block X is a block to be subjected to an intra process, the following equation is applied:

mvₓ=0 (12)

Prediction motion vector information pmv_sub_{E} of the sub-pixel based motion vector information mv_sub_{E} for the target block E is generated using median prediction as follows:

pmv_sub_{E}=med(mv_sub_{A},mv_sub_{B},mv_sub_{c}) (13)

Note that in practice, the process is independently performed for a horizontal-direction component and a vertical-direction component of the motion vector information. In addition, if the motion vector information regarding the block C is unavailable because, for example, the block C is located at the end of the image frame or the block C has not yet been encoded, the motion vector information regarding the block D is used in place of the motion vector information regarding the block C.

Data mvd_sub_{E} to be added to the header portion of the compressed image as the sub-pixel based motion vector information regarding the target block E is given using pmv_sub_{E} as follows:

mvd_sub_{E}=mv_sub_{E}−pmv_sub_{E} (14)

In this way, the motion vector information is generated, and the generated motion vector information is supplied to the template motion prediction/compensation unit 76 together with the generated predicted image. Thereafter, the motion vector information is also used when the cost function value is computed in step S75 described below. When the predicted image generated in the inter template prediction mode is finally selected by the predicted image selecting unit 78, the motion vector information is output to the lossless encoding unit 66 together with the prediction mode information.

Note that for the sub-pixel based motion vector information, a plurality of prediction motion vector information items can be generated using the MV Competition method illustrated in FIG. 14. Thereafter, the optimal one can be selected from among the prediction motion vector information items, and mvd_sub_{E} can be generated.

Referring back to FIG. 15, in step S74, the sub-pixel accuracy motion prediction/compensation unit 77 performs a template skip determination process. The template skip determination process is described in more detail below with reference to FIG. 17. In the template skip determination process, if it is determined that the target block indicates template matching skipping, a 1-bit flag TM_skip_frag for indicating template matching skipping is set to 1.

In step S75, the template motion prediction/compensation unit 76 computes the cost function value for the inter template prediction mode using the above-described equation (7) or (8). The computed cost function value is used when the optimal inter prediction mode is selected in step S34 shown in FIG. 8.

The template skip determination process performed in step S74 shown in FIG. 15 is described next with reference to a flowchart shown in FIG. 17.

In step S91, the sub-pixel accuracy motion prediction/compensation unit 77 determines whether the block size of the target block is a size of 16×16 pixels. If, in step S91, it is determined that the block size is a size of 16×16 pixels, the sub-pixel accuracy motion prediction/compensation unit 77, in step S92, determines whether the motion vector information mvd_sub_{E} generated in step S73 shown in FIG. 15 is 0.

If, in step S92, it is determined that mvd_sub_{E} is 0, the sub-pixel accuracy motion prediction/compensation unit 77, in step S93, determines whether all of the orthogonal transform coefficients are 0. If, in step S93, it is determined that all of the orthogonal transform coefficients are 0, the sub-pixel accuracy motion prediction/compensation unit 77, in step S94, determines that the target block indicates template matching skipping and sets the 1-bit flag indicating template matching skipping to 1.

This flag is also used when the cost function value is computed in step S75 shown in FIG. 15. When the predicted image selecting unit 78 finally selects the corresponding predicted image and if TM_skip_frag=1, only “TM_skip_frag=1” is output to the lossless encoding unit 66.

That is, in this case, since the target block is a block used for obtaining the motion vector information using the pixels spatially located in the reference frame at corresponding positions, it is not necessary to encode the motion vector information. Only encoding of “TM_skip_frag=1” is sufficient. Thus, the encoding efficiency may be further increased.

However, if, in step S91, it is determined that the block size is not a size of 16×16 pixels or if, in step S92, it is determined that mvd_sub_{E} is not 0 or if, in step S93, it is determined that all of the orthogonal transform coefficients are not 0, the sub-pixel accuracy motion prediction/compensation unit 77, in step S95, determines that the target block does not indicate template matching skipping and sets the 1-bit flag TM_skip_frag indicating template matching skip to 0.

When TM_skip_frag=0 and if the corresponding predicted image is finally selected by the predicted image selecting unit 78, the motion vector information mvd_sub_{E} is output to the lossless encoding unit 66. Thus, the orthogonal transform coefficients and the motion vector information mvd_sub_{E} are also encoded.

Note that for simplicity, the sub-pixel accuracy motion prediction/compensation unit 77 performs the template skip determination process. However, in practice, the predicted image selecting unit 78 finally selects the predicted image predicted in the motion prediction/compensation process of the inter template prediction mode. Thereafter, the difference for the predicted image is computed, is subjected to orthogonal transform, and is quantized. When the coefficient after quantization has been performed is 0 and if it is determined that the motion vector information mvd_sub_{E} is 0, TM_skip_frag is set to 1.

As described above, when a motion prediction/compensation process is performed in the inter template prediction mode, the motion prediction and compensation process is performed for each of the integer pixels of a block to be processed using a template matching method. In addition, the motion prediction/compensation process is performed for each of the sub-pixels of the block to be processed using, for example, a block matching method. Thereafter, the searched motion vector information is transmitted to the image decoding apparatus 101. Accordingly, degradation of the prediction performance (the residual error) can be prevented. As a result, a decrease in the encoding accuracy can be prevented.

In addition, at that time, a difference between the sub-pixel based motion vector information and the prediction motion vector information is computed and is encoded. Accordingly, a decrease in the encoding accuracy can be further prevented.

Furthermore, when the block size is a size of 16×16 pixels and if mvd_sub_{E} is 0 and all of the orthogonal transform coefficients are 0, only the 1-bit flag TM_skip_frag (=1) indicating template matching skipping is encoded. Accordingly, the encoding efficiency can be further increased.

The encoded and compressed image is transferred via a predetermined transmission line and is decoded by an image decoding apparatus. FIG. 18 illustrates the configuration of such an image decoding apparatus according to an embodiment of the present invention.

An image decoding apparatus 101 includes a accumulation buffer 111, a lossless decoding unit 112, an inverse quantizer unit 113, an inverse orthogonal transform unit 114, a computing unit 115, a de-blocking filter 116, a re-ordering screen buffer 117, a D/A conversion unit 118, a frame memory 119, a switch 120, an intra prediction unit 121, a motion prediction/compensation unit 122, a template motion prediction/compensation unit 123, a sub-pixel accuracy motion prediction/compensation unit 124, and a switch 125.

The accumulation buffer 111 accumulates transmitted compressed images. The lossless decoding unit 112 decodes information encoded by the lossless encoding unit 66 shown in FIG. 1 and supplied from the accumulation buffer 111 using a method corresponding to the encoding method employed by the lossless encoding unit 66 shown in FIG. 1. The inverse quantizer unit 113 inverse quantizes an image decoded by the lossless decoding unit 112 using a method corresponding to the quantizing method employed by the quantizer unit 65 shown in FIG. 1. The inverse orthogonal transform unit 114 inverse orthogonal transforms the output of the inverse quantizer unit 113 using a method corresponding to the orthogonal transform method employed by the orthogonal transform unit 64 shown in FIG. 1.

The inverse orthogonal transformed output is added to the predicted image supplied from the switch 125 and is decoded by the computing unit 115. The de-blocking filter 116 removes block distortion of the decoded image and supplies the image to the frame memory 119. Thus, the image is accumulated. At the same time, the image is output to the re-ordering screen buffer 117.

The re-ordering screen buffer 117 re-orders images. That is, the order of frames that has been changed by the re-ordering screen buffer 62 shown in FIG. 1 for encoding is changed back to the original display order. The D/A conversion unit 118 D/A-converts an image supplied from the re-ordering screen buffer 117 and outputs the image to a display (not shown), which displays the image.

The switch 120 reads, from the frame memory 119, an image to be inter processed and an image to be referenced. The switch 120 outputs the images to the motion prediction/compensation unit 122. In addition, the switch 120 reads an image used for intra prediction from the frame memory 119 and supplies the image to the intra prediction unit 121.

The intra prediction unit 121 receives, from the lossless decoding unit 112, information regarding an intra prediction mode obtained by decoding the header information. The intra prediction unit 121 generates a predicted image on the basis of such information and outputs the generated predicted image to the switch 125.

The motion prediction/compensation unit 122 receives information regarding an intra prediction mode obtained by decoding the header information (the prediction mode information, the motion vector information, and the reference frame information) from the lossless decoding unit 112. Upon receiving inter prediction mode information, the motion prediction/compensation unit 122 performs a motion prediction and compensation process on the image on the basis of the motion vector information and the reference frame information and generates a predicted image. In contrast, upon receiving inter template prediction mode information, the motion prediction/compensation unit 122 supplies, to the template motion prediction/compensation unit 123, the image read from the frame memory 119 and to be inter processed and the reference image. The template motion prediction/compensation unit 123 performs a motion prediction/compensation process in an inter template prediction mode.

In addition, the motion prediction/compensation unit 122 outputs, to the switch 125, one of the predicted image generated in the inter prediction mode and the predicted image generated in the inter template prediction mode in accordance with the prediction mode information.

The template motion prediction/compensation unit 123 and the sub-pixel accuracy motion prediction/compensation unit 124 perform a motion prediction/compensation process in the inter template prediction mode. The template motion prediction/compensation unit 123 performs an integer-pixel based motion prediction and compensation process of the motion prediction and compensation processes. In contrast, the sub-pixel accuracy motion prediction/compensation unit 124 performs a sub-pixel based motion prediction and compensation process of the motion prediction and compensation processes.

That is, the template motion prediction/compensation unit 123 performs an integer-pixel based motion prediction and compensation process in the inter template prediction mode using the image read from the frame memory 119 and to be inter processed and the image to be referenced. Thus, the template motion estimation/compensation unit 123 generates a predicted image. Note that the motion prediction/compensation process is substantially the same as that performed by the template motion prediction/compensation unit 76 of the image encoding apparatus 51.

In addition, the template motion prediction/compensation unit 123 supplies, to the sub-pixel accuracy motion prediction/compensation unit 124, the image read from the frame memory 119 and to be inter processed and the image to be referenced. Furthermore, the template motion prediction/compensation unit 123 supplies the generated predicted image and the predicted image generated by the sub-pixel accuracy motion prediction/compensation unit 124 to the motion prediction/compensation unit 122.

The sub-pixel accuracy motion prediction/compensation unit 124 receives information obtained by decoding the header information (the motion vector information or the flag information) supplied from the lossless decoding unit 112. The sub-pixel accuracy motion prediction/compensation unit 124 performs a motion prediction and compensation process on the image on the basis of the supplied motion vector information or flag information. Thus, the sub-pixel accuracy motion estimation/compensation unit 124 generates a predicted image. The predicted image is output to the template motion prediction/compensation unit 123.

The switch 125 selects one of the predicted image generated by the motion prediction/compensation unit 122 and the predicted image generated by the intra prediction unit 121 and supplies the selected one to the computing unit 115.

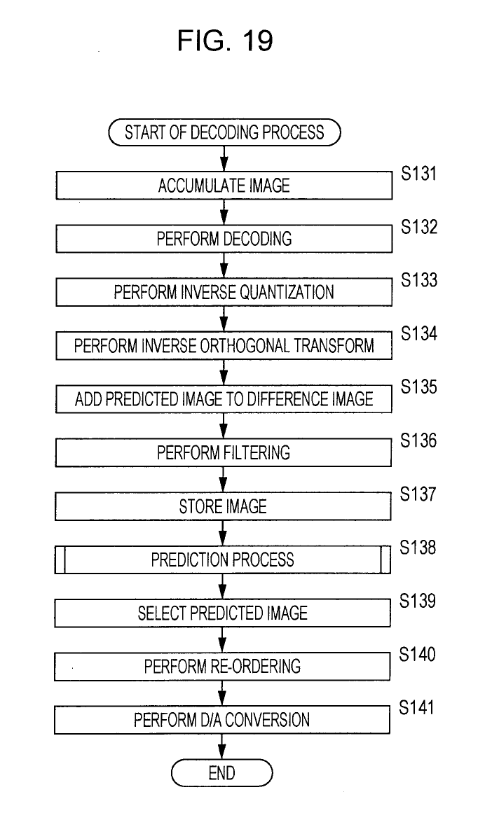

The decoding process performed by the image decoding apparatus 101 is described next with reference to a flowchart shown in FIG. 19.

In step S131, the accumulation buffer 111 accumulates a transferred image. In step S132, the lossless decoding unit 112 decodes a compressed image supplied from the accumulation buffer 111. That is, the I picture, the P picture, and the B picture encoded by the lossless encoding unit 66 shown in FIG. 1 are decoded.

At that time, the motion vector information, the reference frame information, the prediction mode information (information indicating one of an intra prediction mode, an inter prediction mode, and an inter template prediction mode), and the flag information are also decoded. That is, if the prediction mode information is intra prediction mode information, the prediction mode information is supplied to the intra prediction unit 121.

However, if the prediction mode information is inter prediction mode information, the prediction mode information and the corresponding motion vector information are supplied to the motion prediction/compensation unit 122. If the prediction mode information is inter template prediction mode information, the prediction mode information is supplied to the motion prediction/compensation unit 122, and the corresponding motion vector information or the flag information indicating template matching skipping is supplied to the sub-pixel accuracy motion prediction/compensation unit 124.

Note that if the flag information indicating template matching skipping is decoded, orthogonal transform coefficients having values of 0 are supplied to the inverse quantizer unit 113.

In step S133, the inverse quantizer unit 113 inverse quantizes the transform coefficients decoded by the lossless decoding unit 112 using the characteristics corresponding to the characteristics of the quantizer unit 65 shown in FIG. 1. In step 5134, the inverse orthogonal transform unit 114 inverse orthogonal transforms the transform coefficients inverse quantized by the inverse quantizer unit 113 using the characteristics corresponding to the characteristics of the orthogonal transform unit 64 shown in FIG. 1. In this way, the difference information corresponding to the input of the orthogonal transform unit 64 shown in FIG. 1 (the output of the computing unit 63) is decoded.

In step S135, the computing unit 115 adds the predicted image selected in step S141 described below and input via the switch 125 to the difference image. In this way, the original image is decoded. In step S136, the de-blocking filter 116 performs filtering on the image output from the computing unit 115. Thus, block distortion is removed. In step S137, the frame memory 119 stores the filtered image.

In step S138, the intra prediction unit 121, the motion prediction/compensation unit 122, or a pair consisting of the template motion prediction/compensation unit 123 and the sub-pixel accuracy motion prediction/compensation unit 124 performs an image prediction process in accordance with the prediction mode information supplied from the lossless decoding unit 112.

That is, when the intra prediction mode information is supplied from the lossless decoding unit 112, the intra prediction unit 121 performs an intra prediction process in the intra prediction mode. When the inter prediction mode information is supplied from the lossless decoding unit 112, the motion prediction/compensation unit 122 performs a motion prediction and compensation process in the inter prediction mode. However, when the inter template prediction mode information is supplied from the lossless decoding unit 112, the template motion prediction/compensation unit 123 and the sub-pixel accuracy motion prediction/compensation unit 124 perform a motion prediction/compensation process in the inter template prediction mode.

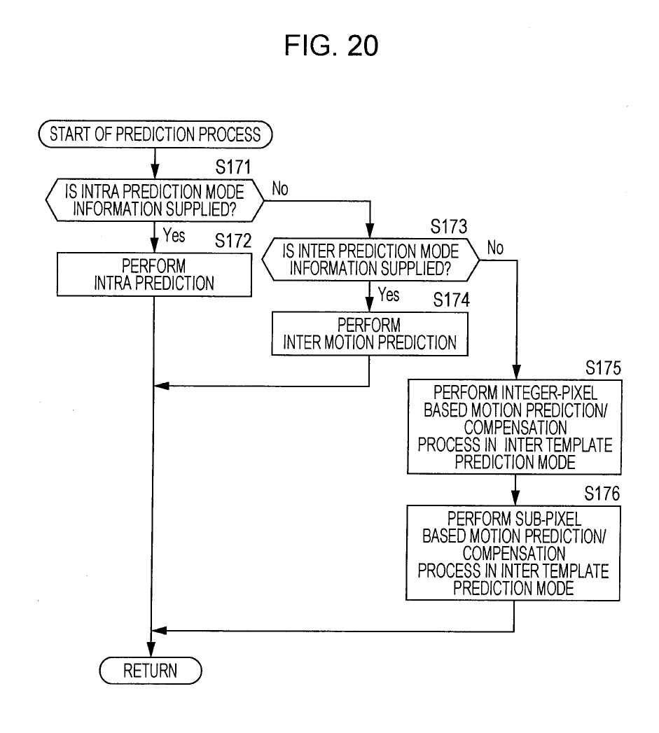

The prediction process performed in step S138 is described below with reference to FIG. 20. Through this process, the predicted image generated by the intra prediction unit 121, the predicted image generated by the motion prediction/compensation unit 122, or the predicted image generated by the template motion prediction/compensation unit 123 and the sub-pixel accuracy motion prediction/compensation unit 124 is supplied to the switch 125.

In step S139, the switch 125 selects the predicted image. That is, since the predicted image generated by the intra prediction unit 121, the predicted image generated by the motion prediction/compensation unit 122, or the predicted image generated by the template motion prediction/compensation unit 123 and the sub-pixel accuracy motion prediction/compensation unit 124 is supplied, the supplied predicted image is selected and supplied to the computing unit 115. As described above, in step S134, the predicted image is added to the output of the inverse orthogonal transform unit 114.

In step S140, the re-ordering screen buffer 117 performs a re-ordering process. That is, the order of frames that has been changed by the re-ordering screen buffer 62 of the image encoding apparatus 51 for encoding is changed back to the original display order.

In step S141, the D/A conversion unit 118 D/A-converts images supplied from the re-ordering screen buffer 117. The images are output to a display (not shown), which displays the images.

The prediction process performed in step S138 shown in FIG. 19 is described next with reference to a flowchart shown in FIG. 20.

If the image to be processed is an image to be subjected to an intra process, intra prediction mode information is supplied from the lossless decoding unit 112 to the intra prediction unit 121. In step S171, the intra prediction unit 121 determines whether intra prediction mode information is supplied. If the intra prediction unit 121 determines that intra prediction mode information is supplied, the intra prediction unit 121 performs intra prediction in step S172.

That is, if the image to be processed is an image to be intra processed, necessary images are read from the frame memory 119. The readout images are supplied to the intra prediction unit 121 via the switch 120. In step S172, the intra prediction unit 121 performs intra prediction in accordance with the intra prediction mode information supplied from the lossless decoding unit 112 and generates a predicted image.

However, if, in step S171, the intra prediction unit 121 determines that intra prediction mode information is not supplied, the processing proceeds to step S173.

If the image to be processed is an image to be inter processed, the inter prediction mode information, the reference frame information, and the motion vector information are supplied from the lossless decoding unit 112 to the motion prediction/compensation unit 122. In step S173, the motion prediction/compensation unit 122 determines whether inter prediction mode information is supplied. If the motion prediction/compensation unit 122 determines that inter prediction mode information is supplied, the motion prediction/compensation unit 122 performs inter motion prediction in step S174.

That is, if the image to be processed is an image to be subjected to an inter prediction process, necessary images are read from the frame memory 119. The readout images are supplied to the motion prediction/compensation unit 122 via the switch 120. In step S174, the motion prediction/compensation unit 122 performs motion prediction in an inter prediction mode on the basis of the motion vector supplied from the lossless decoding unit 112 and generates a predicted image.

If, in step S171, it is determined that inter prediction mode information is not supplied, the processing proceeds to step S175. That is, since the inter template prediction mode information is supplied, the motion prediction/compensation unit 122, in steps S175 and S176, instructs the template motion prediction/compensation unit 123 and the sub-pixel accuracy motion prediction/compensation unit 124 to perform a motion prediction/compensation process in the inter template prediction mode.

More specifically, if the image to be processed is an image to be subjected to an inter template prediction process, necessary images are read from the frame memory 119. The readout images are supplied to the template motion prediction/compensation unit 123 via the switch 120 and the motion prediction/compensation unit 122. In addition, the necessary images are supplied to the sub-pixel accuracy motion prediction/compensation unit 124 via the template motion prediction/compensation unit 123. Furthermore, the sub-pixel accuracy motion vector information or the flag information (TM_skip_frag=1) is supplied from the lossless decoding unit 112 to the sub-pixel accuracy motion prediction/compensation unit 124.

In step S175, the template motion prediction/compensation unit 123 performs an integer-pixel based motion prediction and compensation in the inter template prediction mode. That is, the template motion prediction/compensation unit 123 searches for an integer-pixel based motion vector using an inter template matching method and performs a motion prediction and compensation process on the reference image on the basis of the motion vector. Thus, the template motion prediction/compensation unit 123 generates a predicted image.

In step S176, the sub-pixel accuracy motion prediction/compensation unit 124 performs a motion prediction and compensation process on the reference image on the basis of the sub-pixel based motion vector information supplied from the lossless decoding unit 112 or the flag information (TM_skip_frag=1). Thus, the sub-pixel accuracy motion prediction/compensation unit 124 generates a predicted image.

Note that the decoded sub-pixel based motion vector information is the difference information (mvd_sub_{E}) between the motion vector information computed in step S72 shown in FIG. 15 and the prediction motion vector information generated using the motion vector information regarding a neighboring block using the above-described MV competition method while referring to equation (13) or FIG. 14 in step S73.

Accordingly, as in the sub-pixel accuracy motion prediction/compensation unit 77, the sub-pixel accuracy motion prediction/compensation unit 124 generates prediction motion vector information and adds the generated prediction motion vector information to the decoded sub-pixel based motion vector information. Thus, the sub-pixel accuracy motion prediction/compensation unit 124 computes sub-pixel based motion vector information. Thereafter, the sub-pixel accuracy motion prediction/compensation unit 124 generates a predicted image using the computed sub-pixel based motion vector information.

In contrast, if the flag information is supplied, the target block is a block used for computing motion vector information using the pixels in the reference frame at spatially corresponding positions. Accordingly, a predicted image is generated using the corresponding pixels of the reference image.

As described above, by performing integer-pixel accuracy motion prediction using a template matching method in both an image encoding apparatus and an image decoding apparatus, an image can be displayed with an excellent image quality without sending an integer-pixel accuracy motion vector.

In addition, by encoding a sub-pixel accuracy motion vector into a compressed image and sending the sub-pixel accuracy motion vector to the image decoding apparatus while performing integer-pixel accuracy motion prediction using a template matching method in both the image encoding apparatus and image decoding apparatus, a decrease in the compression ratio can be prevented.

Furthermore, when an H.264/AVC motion prediction/compensation process is performed, prediction using a template matching method is also performed. Thereafter, the one having a higher cost function value is selected, and the encoding process is performed. Thus, the efficiency of encoding can be increased.

While the above description has been made with reference to the case in which the H.264/AVC standard is employed, another encoding method/decoding method can be employed.

Note that the present invention is applicable to an image encoding apparatus and an image decoding apparatus used for receiving image information (a bit stream) compressed through the orthogonal transform (e.g., discrete cosine transform) and motion compensation as in the MPEG or H.26× standard via a network medium, such as satellite broadcasting, a cable TV (television), the Internet, or a cell phone or processing image information in a storage medium such as an optical or magnetic disk, or a flash memory.

The above-described series of processes can be executed not only by hardware but also by software. When the above-described series of processes are executed by software, the programs of the software are installed from a program recording medium into a computer incorporated into dedicated hardware or a computer that can execute a variety of functions by installing a variety of programs therein (e.g., a general-purpose personal computer).

Examples of the program recording medium that records a computer-executable program include a magnetic disk (including a flexible disk), an optical disk (including a CD-ROM (Compact Disc-Read Only Memory), a DVD (Digital Versatile Disc), and a magnetooptical disk), a removable medium which is a package medium formed from a semiconductor memory), and a ROM and a hard disk that temporarily or permanently stores the programs. The programs are recorded in the program recording medium using a wired or wireless communication medium, such as a local area network, the Internet, or digital satellite broadcasting, as needed.

In the present specification, the steps that describe the program include not only processes executed in the above-described time-series sequence, but also processes that may be executed in parallel or independently.

Embodiments of the present invention are not limited to the above-described embodiments. Various modifications can be made without departing from the spirit of the present invention.

### REFERENCE SIGNS LIST

51 image encoding apparatus
66 lossless encoding unit
74 intra prediction unit
75 motion prediction/compensation unit
76 template motion prediction/compensation unit
77 sub-pixel accuracy motion prediction/compensation unit
78 predicted image selecting unit
112 lossless decoding unit
121 intra prediction unit
122 motion prediction/compensation unit
123 template motion prediction/compensation unit
124 sub-pixel accuracy motion prediction/compensation unit
125 switch

1. An image processing apparatus comprising:
a decoding unit configured to decode encoded motion vector information;
a first motion prediction and compensation unit configured to generate a predicted image with integer-pixel accuracy for a first target block of a frame by searching for a motion vector using a template that is adjacent to the first target block with a predetermined positional relationship and that is generated from a decoded image; and
a second motion prediction and compensation unit configured to generate a predicted image with sub-pixel accuracy using sub-pixel accuracy motion vector information regarding the first target block decoded by the decoding unit.

2. The image processing apparatus according to claim 1, wherein the second motion prediction and compensation unit generates a predicted value of the sub-pixel accuracy motion vector using the motion vector information regarding a neighboring block that is adjacent to the first target block and that has already been encoded.

3. The image processing apparatus according to claim 2, wherein the second motion prediction and compensation unit generates motion vector information regarding a co-located block of an encoded frame different from the frame, the co-located block being located at a position corresponding to the first target block, and a block that is adjacent to the co-located block or generates a predicted value of the sub-pixel accuracy motion vector using the motion vector information regarding the co-located block and the neighboring block.

4. The image processing apparatus according to claim 1, further comprising:
a third motion prediction and compensation unit configured to search for a motion vector of a second target block of the frame using the second target block; and
an image selection unit configured to select one of a predicted image based on the motion vector searched for by the first or second motion prediction and compensation unit and a predicted image based on the motion vector searched for by the third motion prediction and compensation unit.

5. An image processing method for use in an image processing apparatus, the method comprising the steps of:
decoding encoded motion vector information;
generating a predicted image with integer-pixel accuracy for a target block of a frame by searching for a motion vector using a template that is adjacent to the target block with a predetermined positional relationship and that is generated from a decoded image; and
generating a predicted image with sub-pixel accuracy using sub-pixel accuracy motion vector information regarding the decoded target block.

6. An image processing apparatus comprising:
a first motion prediction and compensation unit configured to search for an integer-pixel accuracy motion vector of a first target block of a frame using a template that is adjacent to the first target block with a predetermined positional relationship and that is generated from a decoded image;
a second motion prediction and compensation unit configured to search for a sub-pixel accuracy motion vector of the first target block using the first target block; and
an encoding unit configured to encode information regarding the sub-pixel accuracy motion vector searched for by the second motion prediction and compensation unit as information regarding a motion vector of the first target block.

7. The image processing apparatus according to claim 6, wherein the second motion prediction and compensation unit generates a predicted value of the sub-pixel accuracy motion vector using the motion vector information regarding a neighboring block that is adjacent to the first target block and that has already been encoded, and wherein the encoding unit encodes a difference between the information regarding the sub-pixel accuracy motion vector and the predicted value as the motion vector information regarding the first target block.

8. The image processing apparatus according to claim 7, wherein the second motion prediction and compensation unit generates motion vector information regarding a co-located block of an encoded frame different from the frame, the co-located block being located at a position corresponding to the first target block, and a block regarding a block that is adjacent to the co-located block or generates the predicted value of the sub-pixel accuracy motion vector using the motion vector information regarding the co-located block and the neighboring block, and wherein the encoding unit encodes a difference between the information regarding the sub-pixel accuracy motion vector and the predicted value as motion vector information regarding the first target block.

9. The image processing apparatus according to claim 6, wherein when the size of the first target block is a size of 16×16 pixels and if the predicted value of the sub-pixel accuracy motion vector is 0 and all of orthogonal transform coefficients are 0, the encoding unit encodes only a flag indicating that the first target block is a template skip block as the motion vector information regarding the first target block.

10. The image processing apparatus according to claim 6, further comprising:
a third motion prediction and compensation unit configured to search for a motion vector of a second target block of the frame using the second target block; and
an image selection unit configured to select one of a predicted image based on the motion vector searched for by the first or second motion prediction and compensation unit and a predicted image based on the motion vector searched for by the third motion prediction and compensation unit.

11. The image processing apparatus according to claim 10, wherein upon performing arithmetic coding, the encoding unit defines first context for the first target block that is a target of the first and second motion prediction and compensation units and second context for the second target block that is a target of the third motion prediction and compensation unit, and wherein the encoding unit encodes the information regarding the motion vector of the first target block using the first context and encodes the information regarding the motion vector of the second target block using the second context.

12. The image processing apparatus according to claim 10, wherein upon performing arithmetic coding, the encoding unit defines one context, and wherein the encoding unit encodes the information regarding the motion vector of the first target block and the information regarding the motion vector of the second target block using the context.

13. The image processing apparatus according to claim 10, wherein upon performing arithmetic coding, the encoding unit defines first context for information regarding a motion vector with integer-pixel accuracy and second context for information regarding a sub-pixel accuracy motion vector, and wherein the encoding unit encodes the information regarding the sub-pixel accuracy motion vector among information regarding motion vectors of the first target block using the second context, and wherein the encoding unit encodes the information regarding the motion vector with integer-pixel accuracy among information regarding motion vectors of the second target block using the first context and encodes the information regarding the motion vector with sub-pixel accuracy using the second context.

14. An image processing method for use in an image processing apparatus, the method comprising the steps of:
searching for an integer-pixel accuracy motion vector of a target block of a frame using a template that is adjacent to the target block with a predetermined positional relationship and that is generated from a decoded image;
searching for a sub-pixel accuracy motion vector of the target block using the target block; and
encoding information regarding the searched sub-pixel accuracy motion vector as information regarding a motion vector of the target block.
